(19) United States
(12) Patent Application Publication
(10) Pub. No.: US 2015/0038045 A1
(43) Pub. Date: Feb. 5, 2015

(54) REMOTE CONTROL HELICOPTER TOY WITH DOUBLE PROPELLERS ON EMPENNAGE

(71) Applicant: Rizhuang LIN, Shenzhen (CN)

(72) Inventor: Rizhuang LIN, Shenzhen (CN)

(21) Appl. No.: 14/519,537

(22) Filed: Oct. 21, 2014

(30) Foreign Application Priority Data
Jan. 6, 2014 (CN) 201410005323.X

(51) Int. Cl. A63H 27/00

(52) U.S. Cl. CPC A63H 27/12; B64C 2203/00
USPC 446/37

(57) ABSTRACT

The present invention discloses a remote control helicopter toy with double propellers on the empennage. The remote control helicopter toy with double propellers on the empennage comprises a helicopter body (100), a power supply, a control circuit board (110), a main propeller device (200) and a tail propeller device (300). The power supply and the control circuit board (110) are disposed inside the helicopter body (100); the main propeller device (200) and the tail propeller device (300) are electrically connected to the control circuit board (110); and the tail propeller device (300) comprises a left propeller (320) and a right propeller (310), which are disposed bilaterally symmetrically in a tail part of the helicopter body (100).

### FIELD OF THE INVENTION

The present invention belongs to the technical field of toys, in particular to a remote control helicopter toy.

### BACKGROUND OF THE INVENTION

Remote control helicopter toys, as they can realize remote-controlled flying in the air, are widely popular in the majority of children. However, when played, the existing remote control helicopter toys cannot meet the requirements of the majority of children due to lack of novelty and being not that interesting, because the main power is supplied by a main propeller device provided in the middle of the helicopter body, and the existing remote control helicopter toys turn left and right or fly up and down through the differential or constant rotation of two coaxial propellers inside the main propeller device, and may not turn freely or fly sideways to the left or right as being controlled to fly forward or backward by only one propeller on the empennage.

### SUMMARY OF THE INVENTION

An objective of the present invention is to provide a remote control helicopter toy with double propellers on the empennage, which may turn freely and fly sideways to the left or right.

The present invention is accomplished by the following technical solution. [0005] A remote control helicopter toy with double propellers on the empennage is provided, including a helicopter body, a power supply, a control circuit board, a main propeller device and a tail propeller device; the power supply and the control circuit board are disposed inside the helicopter body; the main propeller device and the tail propeller device are electrically connected to the control circuit board; and the tail propeller device includes a left propeller and a right propeller, which are disposed bilaterally symmetrically in a tail part of the helicopter body.

As a further improvement to the technical solution mentioned above, the main propeller device includes a pair of coaxial propellers disposed vertically upward.

As a further improvement to the technical solution mentioned above, the left propeller and the right propeller are preferably disposed vertically upward. Certainly, the left propeller and the right propeller may be disposed bilaterally symmetrically, such as, disposed vertically upward or disposed upward by tilting by 45 degrees outward.

As a further improvement to the technical solution mentioned above, the left propeller and the right propeller each include, the direction and speed of rotation of which are controlled by the control circuit board to fly forward or backward or fly sideways to the left or right, blades and driving motor assemblies for driving the blades.

As a further improvement to the technical solution mentioned above, a propeller is further provided in the center of the tail part of the helicopter body (100).

The present invention has the following beneficial effects. The remote control helicopter toy with double propellers on the empennage of the present invention includes a helicopter body, a main propeller device and a tail propeller device; and the tail propeller device includes a left propeller and a right propeller, which are disposed bilaterally symmetrically in a tail part of the helicopter body. Thus, the remote control helicopter toy with double propellers on the empennage can turn freely and fly sideways to the left or right due to the forces provided by the left propeller and the right propeller, and can also fly forward or backward faster.

### BRIEF DESCRIPTION OF THE DRAWINGS

FIG. 1 is a schematic diagram of a remote control helicopter toy with double propellers on the empennage according to one embodiment of the present invention; and

FIG. 2 is a cutaway diagram of the remote control helicopter toy with double propellers on the empennage of FIG. 1.

### DETAILED DESCRIPTION OF THE PREFERRED EMBODIMENTS

The specific implementations of the present invention will be further described as below with reference to the accompanying drawings.

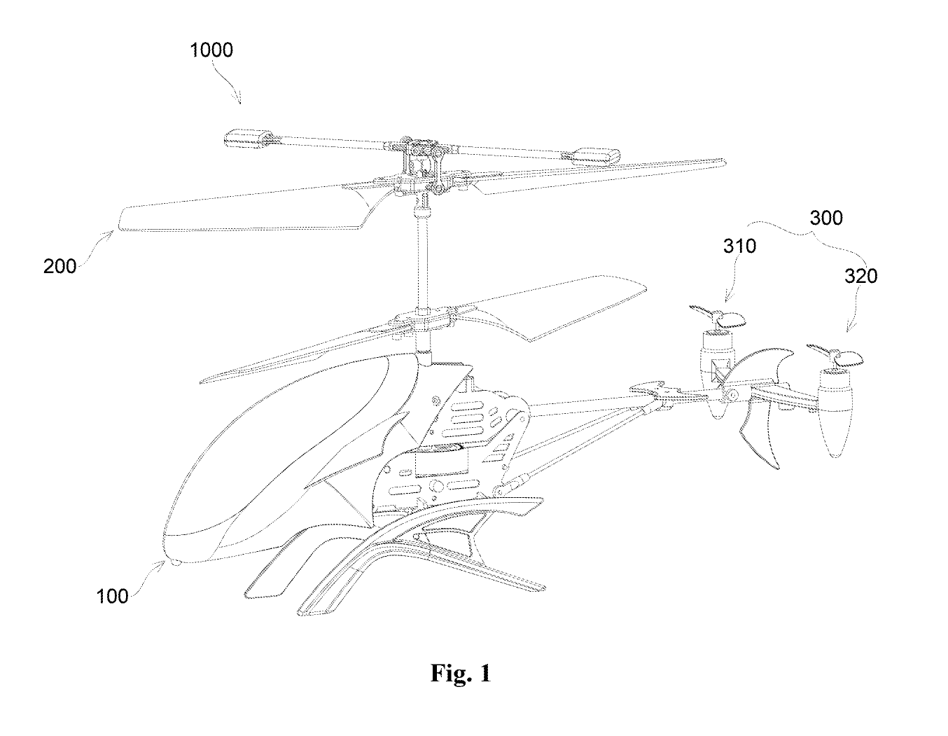

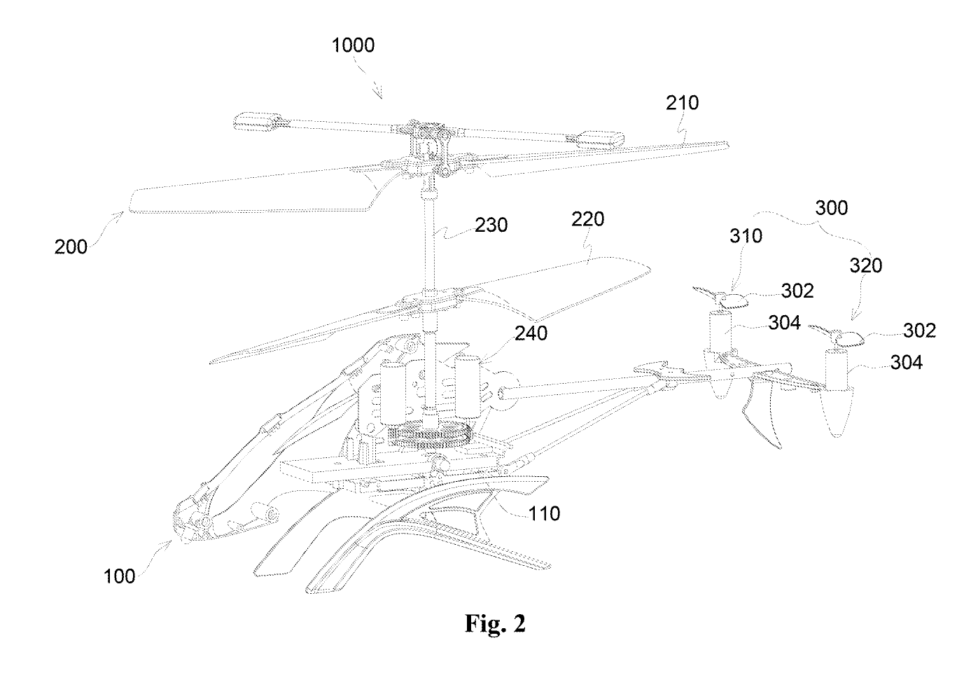

As illustrated in FIG. 1 and FIG. 2, a remote control helicopter toy 1000 with double propellers on the empennage of this embodiment includes a helicopter body 100, a power supply, a control circuit board 110, a main propeller device 200 and a tail propeller device 300. The power supply which is used for supplying power to the remote control helicopter toy 1000 with double propellers on the empennage, and the control circuit board 110 are disposed inside the helicopter body 100. The main propeller device 200 and the tail propeller device 300 are electrically connected to the control circuit board 110. The tail propeller device 300 includes a left propeller 320 and a right propeller 310, which are disposed bilaterally symmetrically in a tail part of the helicopter body 100. Preferably, the left propeller 320 and the right propeller 310 are disposed vertically upward in the tail part of the helicopter body 100. Moreover, in this embodiment, the left propeller 320 and the right propeller 310 have a same structure.

The main propeller device 200 includes a pair of coaxial propellers disposed vertically upward (i.e., upper propeller 210 and lower propeller 220), a rotating shaft structure 230 and a driving mechanism 240. The driving mechanism 240 includes a driving motor, a gear reducer mechanism and on the like. The power of the driving mechanism 240 is transferred to the upper propeller 210 and the lower propeller 220 via the rotating shaft structure 230, and the differential or constant rotation of the two coaxial propellers 210, 220 inside the main propeller device 200 is controlled by the control circuit board 110, so that the helicopter turns left and right or flies up and down. [0016] As illustrated in FIG. 2, the left propeller 320 and the right propeller 310 each include blades 302 and driving motor assemblies 304 for driving the blades 302. The direction and speed of rotation of the left propeller 320 and the right propeller 310 are controlled by the control circuit board 110. Certainly, the blades on the left propeller 320 and the right propeller 310 may be controlled to rotate in opposite directions by the control circuit board 110 as required. The driving motor assemblies 304 may include a driving motor and/or a reducer mechanism, etc. In addition, the driving mechanism 240 and the driving motor assemblies 304 are remotely controlled by a hand-held remote control (not illustrated).

In the remote control helicopter toy 1000 with double propellers on the empennage of this embodiment, the direction and speed of rotation of the driving motors of the left propeller 320 and the right propeller 310 are controlled by the control circuit board 110. For example, when the left propeller 320 and the right propeller 310 rotate forward in a same direction, the tail part is lifted up and the whole remote control helicopter toy will fly forward; when the left propeller 320 and the right propeller 310 rotate backward in a same direction, the tail part is lifted down and the whole remote control helicopter toy will fly backward; and when the left propeller 320 and the right propeller 310 rotate in a reverse direction, the helicopter body will tilt to the left or right, so that the whole remote control helicopter toy will fly sideways to the left or right. As such, in aid of the double propellers in the tail part, the whole remote control helicopter toy may turn freely and fly sideways to the left or right, thereby making the playing more interesting. Moreover, in aid of the left propeller 320 and the right propeller 310, the remote control helicopter toy 1000 with double propellers on the empennage may fly forward or backward faster.

Although the present invention has been described in details by the specific implementations mentioned above, these specific implementations are not intended to form any limitation to the present invention. The protection scope of the present invention is not limited by the implementations mentioned above, and any equivalent modification or variation made by an ordinary person skilled in the art with reference to the contents disclosed in the present invention shall fall into the protection scope recorded by the claims.

What is claimed is:

1. A remote control helicopter toy with double propellers on the empennage, wherein the remote control helicopter toy (1000) with double propellers on the empennage comprises a helicopter body (100), a power supply, a control circuit board (110), a main propeller device (200) and a tail propeller device (300); the power supply and the control circuit board (110) are disposed inside the helicopter body (100); the main propeller device (200) and the tail propeller device (300) are electrically connected to the control circuit board (110); the tail propeller device (300) comprises a left propeller (320) and a right propeller (310), which are disposed bilaterally symmetrically in a tail part of the helicopter body (100); and the direction and speed of rotation of the left propeller (320) and the right propeller (310) are controlled by the control circuit board.

2. The remote control helicopter toy with double propellers on the empennage according claim 1, wherein the left propeller (320) and the right propeller (310) have a same structure.

3. The remote control helicopter toy with double propellers on the empennage according to claim 2, wherein the left propeller (320) and the right propeller (310) each comprise blades (302) and driving motor assemblies (304) for driving the blades (302).

4. The remote control helicopter toy with double propellers on the empennage according to claim 3, wherein a propeller is further provided in the center of the tail part of the helicopter body (100).

5. The remote control helicopter toy with double propellers on the empennage according to claim 1, wherein the main propeller device (200) comprises a pair of coaxial propellers (210, 220) disposed vertically upward, and the speed of rotation of the two propellers is controlled by the control circuit board.

6. The remote control helicopter toy with double propellers on the empennage according to claim 5, wherein the left propeller (320) and the right propeller (310) have a same structure.

7. The remote control helicopter toy with double propellers on the empennage according to claim 6, wherein the left propeller (320) and the right propeller (310) each comprise blades (302) and driving motor assemblies (304) for driving the blades (302).

8. The remote control helicopter toy with double propellers on the empennage according to claim 7, wherein a propeller is further provided in the center of the tail part of the helicopter body (100).

9. The remote control helicopter toy with double propellers on the empennage according to claim 5, wherein the left propeller (320) and the right propeller (310) are disposed vertically upward.

10. The remote control helicopter toy with double propellers on the empennage according to claim 9, wherein the left propeller (320) and the right propeller (310) have a same structure.

11. The remote control helicopter toy with double propellers on the empennage according to claim 10, wherein the left propeller (320) and the right propeller (310) each comprise blades (302) and driving motor assemblies (304) for driving the blades (302).

12. The remote control helicopter toy with double propellers on the empennage according to claim 11, wherein a propeller is further provided in the center of the tail part of the helicopter body (100).

13. The remote control helicopter toy with double propellers on the empennage according to claim 5, wherein the left propeller (320) and the right propeller (310) are disposed vertically downward.

14. The remote control helicopter toy with double propellers on the empennage according to claim 13, wherein the left propeller (320) and the right propeller (310) have a same structure.

15. The remote control helicopter toy with double propellers on the empennage according to claim 14, wherein the left propeller (320) and the right propeller (310) each comprise blades (302) and driving motor assemblies (304) for driving the blades (302).

16. The remote control helicopter toy with double propellers on the empennage according to claim 15, wherein a propeller is further provided in the center of the tail part of the helicopter body (100).

17. The remote control helicopter toy with double propellers on the empennage according to claim 5, wherein the left propeller (320) and the right propeller (310) are disposed upward by tilting by 45 degrees outward.

18. The remote control helicopter toy with double propellers on the empennage according to claim 17, wherein the left propeller (320) and the right propeller (310) have a same structure.

19. The remote control helicopter toy with double propellers on the empennage according to claim 18, wherein the left propeller (320) and the right propeller (310) each comprise blades (302) and driving motor assemblies (304) for driving the blades (302).

20. The remote control helicopter toy with double propellers on the empennage according to claim 19, wherein a propeller is further provided in the center of the tail part of the helicopter body (100).
